(19) United States
(12) Patent Application Publication
(10) Pub. No.: US 2007/0255554 A1
(43) Pub. Date: Nov. 1, 2007

(54) Language translation service for text message communications

(75) Inventor: Yigang Cai, Naperville, IL (US)

Correspondence Address: Werner Ulrich, 434 Maple St., Glen Ellyn, IL, 60137-3826, US

(73) Assignee: Lucent Technologies Inc.

(21) Appl. No.: 11/411,450

(22) Filed: Apr. 26, 2006

(51) Int. Cl. G06F 17/27

(52) U.S. Cl. 704/9

(57) ABSTRACT

This invention relates to a method and apparatus for providing automatic language translation in a telecommunications network. Communications from a speaker or generator of text in one language are routed to a service center for automatically converting to another language. The service center stores the language preference(s) of destination terminals served by the center. If the input language of a message is one serviced by the center and one of the preferred languages of the destination terminal is serviced by the center, the center translates the message before delivering it to the destination terminal. Advantageously, this arrangement greatly enhances communications between individuals who have no common language in which both are fluent.

### TECHNICAL FIELD

This invention relates to methods and apparatus for communications between terminals whose users speak different languages.

### BACKGROUND OF THE INVENTION

As the globalization movement accelerates, it is becoming more and more necessary to allow communications between parties speaking different languages. Further, the range of languages is rapidly increasing as more of the communications are between people speaking an Asian language (e.g., Chinese, Japanese, Hindi, Philippino, Malay) and one of the European languages or English. While many Asian speakers also know English, the communications between an English speaker and an Asian speaker lay a great burden on the Asian speaker if they are carried out in English, frequently, to the disadvantage of the Asian speaker. This burden is one which the Asian speakers are increasingly reluctant to bear. Unfortunately, the number of English speakers who are also fluent in an Asian language is still small.

Fortunately, software packages which translate between two languages are becoming increasingly sophisticated and of higher quality. For example, SYSTRAN translates between English and any of French, Dutch, Japanese, Chinese, Arabic, Spanish, German, Swedish, Italian, Portuguese and Korean.

A problem of the prior art is that in spite of the above factors, communications between speakers of different languages continue to be inefficient and awkward.

### SUMMARY OF THE INVENTION

The above problem is substantially alleviated and an advance is made over the teachings of the prior art in accordance with this invention wherein communications between speakers of two different languages are routed through a service center in which a text in one language is converted to a text in another language; advantageously, this type of text-to-text translation can typically be carried out with present software packages in as little as one second for a short message.

In accordance with one feature of Applicant's invention, the translated text is converted with essentially no additional delay into spoken text for announcement to a receiving party of a communication. A voice mail message of this type can then be delivered to the recipient at the recipient's convenience.

In accordance with one feature of Applicant's invention, each user specifies a preferred language or two or more languages that are acceptable. If a message is generated in an acceptable language, the translation process is bypassed.

In accordance with another feature of Applicant's invention if the caller is provided with translation software in his/her customer equipment, the network reports to the customer equipment the preferred language(s) of the message recipient. Then if no translation is necessary or the translation is to a language for which the calling customer's terminal has translation capabilities, no translation is required in the network; otherwise, the call is routed to a service center where the required translation is performed.

In accordance with one feature of Applicant's invention, calls which are candidates for translation are identified by a suitable prefix. Calls which do not include such a prefix are processed in the normal manner of the prior art.

Advantageously, these arrangements greatly enhance communications between individuals who have no common language in which both are comfortable and fluent.

### BRIEF DESCRIPTION OF THE DRAWINGS

FIG. 1 is a block diagram illustrating the operation of Applicant's invention; and

FIG. 2 is a flow diagram illustrating the operation of Applicant's invention.

### DETAILED DESCRIPTION

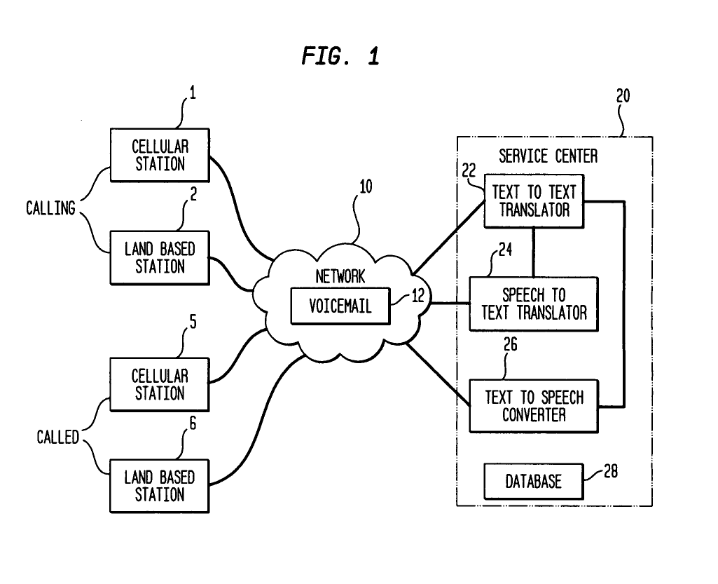

FIG. 1 is a block diagram illustrating the operation of the invention. The calling party has terminal equipment 1 or 2. Terminal equipment 1 is a cellular station equipped to transmit text messages or voice. Terminal 2 is land-based station equipped to transmit text messages or voice. Terminals 1 and 2 can, optionally, be equipped with limited text translation capabilities, which can accept text messages in a first language or one of a plurality of first languages, and can translate the text into one of a plurality of second languages. The called station is one of two stations 5 or 6. Called station 5 is a cellular station equipped to receive text messages or voice messages; land-based station 6 is connected by land-based facilities and is equipped to receive data messages or voice messages. Either of the terminals 5 or 6 can be optionally equipped with software to receive data messages in one language and display or print the translation of these messages into a second language.

The calling and called parties are connected via network 10 which can be a network for transmitting Internet multimedia service (IMS) signals representing data, text data, video, or voice. Network 10 is connected to a service center 20 which includes text-to-text translators 22, speech-to-text translators (operating in a single language) 24, and text-to-speech converters (also operating in a single language) 26. The service center also contains a database 28 for storing the language preferences of destination terminals served by the service center. The service center can be part of an instant message server, an e-mail server, or a short message service server. If the output is to be delivered as speech, a voice mail facility 12 in the network can be used to store and deliver voice signals representing the message. Alternatively, the service center can be a separate unit connected to one of these servers by the network 10; in that case, the service center is called whenever one of the servers recognizes the need to translate a message.

If the desired mode of operation is not simply text to text, but is either speech to text, or text to speech, or speech to speech, then the speech to text translator 24 is used before using the text to text translator 22, or the text to speech converter 26 is used after the text to text translator 22 has finished its work, or both, respectively. The Service Center then sends text to the called party, or sends speech to a voice messaging system for subsequent communication to the called party. Because the text to text translation process is relatively slow, with the present state of the art, speech to speech translation, wherein the translated speech is immediately recognized and can be responded to does not yet appear to be feasible; that is why translated speech is delivered to a voice messaging system for access by the called party. Note that at the present time, simple text to text conversion appears to be the most desirable mode.

If the called party is willing to accept text or speech in one of two, or more, languages, then the service center can decide whether the input language is one of the acceptable languages, and can bypass the translation step.

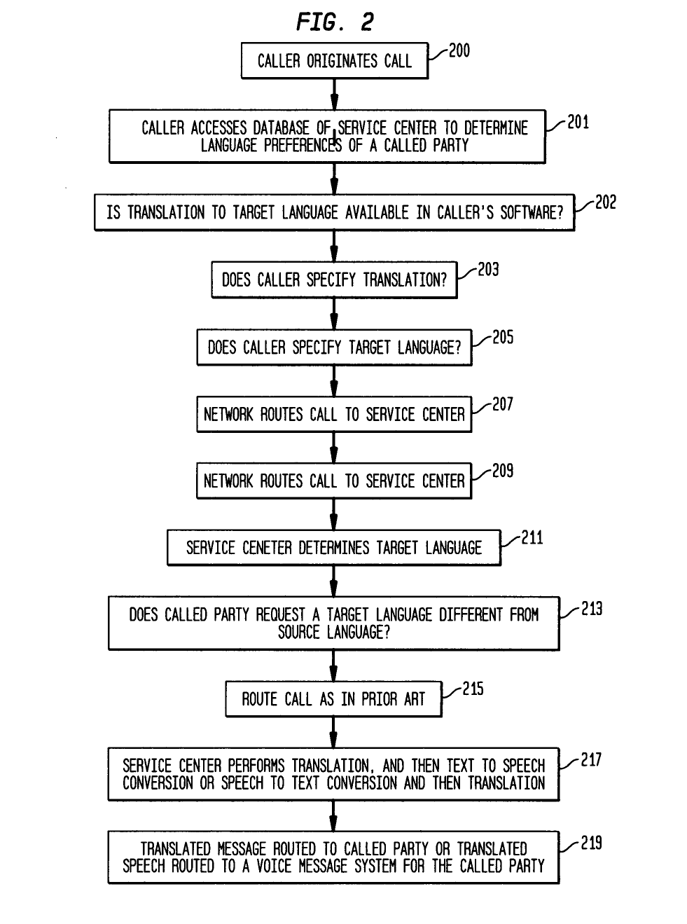

FIG. 2 illustrates the operation of Applicant's invention. A caller originates a call (action block 200). The caller accesses the database of the service center to determine the preferred languages of the destination party (action block 201). Test 202 is used to determine whether the caller wishes to have his/her message translated to a language available in his/her own software. If so, the call is translated and then routed as in the prior art (action block 215). If not, then test 203 is used to determine whether a caller specifies a translation requirement. In the preferred embodiment of Applicant's invention, this is done by using a prefix in the call addressing mechanism. The prefix may also be augmented by treating calls to a set of specified terminating customer equipments as requiring translation. If the caller has specified the translation option, test 205 is used to determine whether the caller specifies the target language. If so, the network routes the call to the service center (action block 207) and specifies to the service center the identity of the target language as well as the language of the original message.

If the caller does not specify the target language, then the network routes the call to the service center (action block 209). The service center then determines the target language (action block 211). If the caller has not specified translation, then test 213 is used to determine whether the called party has requested incoming messages to be translated to one of one or more specific target language and tests whether the different target languages are all different from the source language. If the called party has not requested translation or if the calling party language is the same as a called party target language then the call is routed as in the prior art (action block 215). If the called party has requested translation to a language different from the source language, then the network routes the call to the service center (action block 209, previously discussed).

Following execution of action blocks 207 or 211, the service center performs the translation (action block 217). The translated message is then routed to the called party (action block 219). If the caller inputs voice, the speech to text translator 24 generates text for use by the text to text translator 22 for generating text in the target language. If the called party wishes to have speech delivered, the output of the text to text translator 22 is presented to text to speech converter 26 which then generates a voice mail message for storage in voice mail unit 28 for subsequent delivery to the called party.

Note that if the caller knows that the called party has software for translating from the caller's language to a language desired by the called party, then the call can be handled as in the prior art. In that case, the original request to determine the languages acceptable to the called party includes the source languages from which the called party can make a translation. The called party then must recognize the need for translation and invoke the required software, or can recognize that calls from a specific caller, identified by caller identification, must be translated.

If a message is destined for a plurality of terminals, the service center can generate messages to each of the plurality in the preferred language of that terminal.

In some cases, the recipient of a message may wish to examine the original source text, since translation is an imperfect process. The service center should store the source text, and transmit this source text upon request or routinely.

The above description is of one preferred embodiment of Applicant's invention. Other embodiments will be apparent to those of ordinary skill in the art. The invention is limited only by the attached claims.

I claim:

1. A method of processing a text communications call, comprising the steps of:
determining whether a source language is the same as a preferred target language for a text message call between a source terminal and a destination terminal;
if the source language does not match a preferred target language, routing the call via a service center for automatic translation of a source text in a first language to a destination text in a second language; and
routing said destination text from said service center to said destination terminal.

2. The method of claim 1 further comprising the steps of:
determining whether a caller party wishes to input text by speech; and
converting the input speech text to data text for use as a source text for said automatic translation.

3. The method of claim 1 further comprising the steps of:
determining whether a called party wishes to receive said destination as speech; and
converting said destination text to destination speech prior to transmitting said destination text to said destination terminal.

4. The method of claim 3 further comprising the step of:
transmitting said destination speech to a voice mail system prior to transmitting said destination speech to said destination terminal.

5. The method of claim 1 wherein said destination text is in one of a plurality of acceptable destination languages; and
wherein said translation is bypassed if said source language is one of said acceptable destination languages.

6. The method of claim 1 wherein a source terminal has limited translation capabilities, and said call is routed directly to said destination terminal if said source terminal can translate to a language acceptable to said destination terminal.

7. The method of claim 1 wherein at least one of said source and said destination terminals is a cellular terminal.

8. The method of claim 1 wherein said service center comprises a database for storing language preferences of destination terminals served by said service center.

9. The method of claim 1 wherein said language preferences include languages which a destination terminal can translate.

10. Apparatus for processing a text communications call, comprising:
a service center for automatic translation of a source text in a first language to a destination text in a second language;
means for determining whether a source language is the same as a preferred target language for a text message call between a source terminal and a destination terminal;
if the source language does not match a preferred target language, means for routing the call via said service center for automatic translation of a source text in a first language to a destination text in a second language; and
means for routing said destination text from said service center to said destination terminal.

11. The apparatus of claim 10 further comprising:
means for determining whether a caller party wishes to input text by speech; and
means for converting the input speech text to data text for use as a source text for said automatic translation.

12. The apparatus of claim 10 further comprising:
means for determining whether a called party wishes to receive said destination as speech; and
means for converting said destination text to destination speech prior to transmitting said destination text to said destination terminal.

13. The apparatus of claim 12 further comprising:
a voice mail system;
means for transmitting said destination speech to said voice mail system prior to transmitting said destination speech to said destination terminal.

14. The apparatus of claim 10 wherein said destination text is in one of a plurality of acceptable destination languages; and
wherein said translation by said service center is bypassed if said source language is one of said acceptable destination languages.

15. The apparatus of claim 10 wherein a source terminal comprises limited translation capabilities, and wherein said call is routed directly to said destination terminal if said source terminal can translate to a language acceptable to said destination terminal.

16. The apparatus of claim 10 wherein at least one of said source and said destination terminals is a cellular terminal.

17. The apparatus of claim 10 wherein said service center comprises a database for storing language preferences of destination terminals served by said service center.

18. The apparatus of claim 10 wherein said language preferences include languages which a destination terminal can translate.
